(19) United States
(12) Patent Application Publication
(10) Pub. No.: US 2013/0330979 A1
(43) Pub. Date: Dec. 12, 2013

(54) CONNECTOR FOR A COVERING MEMBER OF A CABLE

(71) Applicant: YVONNE C. HSIA, New Taipei (TW)

(72) Inventor: YVONNE C. HSIA, New Taipei (TW)

(21) Appl. No.: 13/492,812

(22) Filed: Jun. 9, 2012

(51) Int. Cl. H01R 13/40

(52) U.S. Cl. 439/750

(57) ABSTRACT

A connector for a covering member of a cable contains a connector; the covering member, including an outer tube having a first hole, the first hole having an external portion extending outward from a peripheral side of another end thereof, the outer tube being retained in the connector, a bottom end of the external periphery being larger than the first hole; an inner tube having a second hole; a needle portion having a head projection and an engaging section; wherein after the needle projection retains in the second hole of the inner tube, the needle portion and the inner tube are received in the first hole of the outer tube so as to retain in the connector with the outer tube.

### BACKGROUND OF THE INVENTION

1. Field of the Invention

The present invention relates to a connector for a covering member of a cable which is capable of providing waterproof and anti-lost function of the needle portion.

2. Description of the Prior Art

A conventional connector easily suffers damp and so as to influence transmission quality and function. In addition, in the conventional connector, the needle portion is individual separated from the connector body, so during transportation, the needle portion will be easily lost and then cause inconvenience, project delays, parts waste and increased costs.

The present invention has arisen to mitigate and/or obviate the afore-described disadvantages.

### SUMMARY OF THE INVENTION

The primary object of the present invention is to provide a connector for a covering member of a cable in which a needle portion of a connector is attached in the connector in order to prevent its disengagement from the connector.

Another object of the present invention is to provide a connector for a covering member of a cable in which the retained covering member is easily removable and fitted on the cable and inserted into the connector, thereby obtaining waterproof function.

To obtain the above objectives, a connector for a covering member of a cable contains:

a connector;

the covering member, including

an outer tube having a first hole , the first hole having an external portion extending outward from a peripheral side of another end thereof, the outer tube being retained in the connector, a bottom end of the external periphery being larger than the first hole;

an inner tube having a second hole;

a needle portion having a head projection and an engaging section; wherein

after the needle portion retains in the second hole of the inner tube, the needle portion and the inner tube are received in the first hole of the outer tube so as to retain in the connector with the outer tube.

### BRIEF DESCRIPTION OF THE DRAWINGS

FIG. 1 is a perspective view showing the assembly of a connector for a covering member of a cable according to a preferred embodiment of the present invention;

FIG. 2 is a perspective view showing the operation of the connector for the covering member of the cable according to the preferred embodiment of the present invention;

FIG. 3 is a perspective view showing the exploded components of the connector for the covering member of the cable according to the preferred embodiment of the present invention;

FIG. 4 is a perspective view showing the assembly of an inner tube and an outer tube of the connector for the covering member of the cable according to the preferred embodiment of the present invention;

FIG. 5 is a cross-sectional perspective view of FIG. 4;

FIG. 6 is a cross-sectional perspective view showing the assembly of the inner tube, the outer tube, and the needle portion of the connector for the covering member of the cable according to the preferred embodiment of the present invention;

FIG. 7 is a perspective view showing the assembly of the inner tube, the outer tube, and the needle portion of the connector for the covering member of the cable according to the preferred embodiment of the present invention;

FIG. 8 is a cross-sectional perspective view showing the assembly of the cable, the outer tube, and the needle portion of the connector for the covering member of the cable according to the preferred embodiment of the present invention;

FIG. 9 is a perspective view showing the assembly of the connector for the covering member of the cable and the cable according to the preferred embodiment of the present invention;

FIG. 10 is a plan view showing the inner tube of the connector for the covering member according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

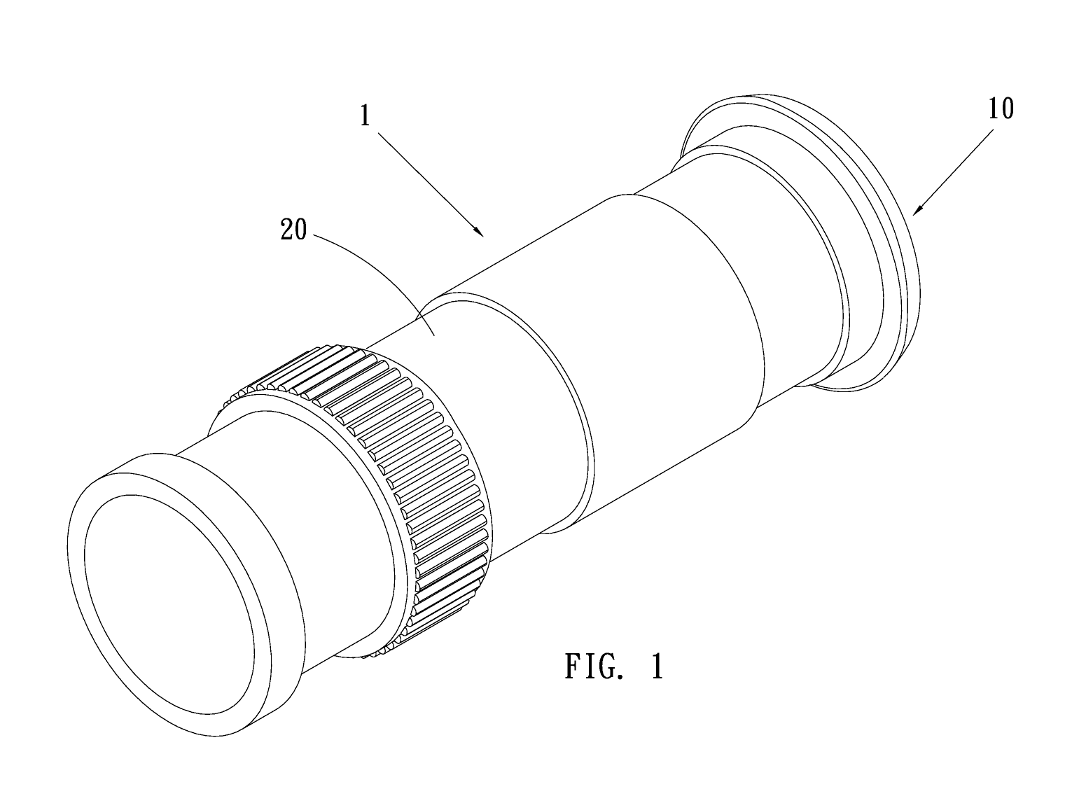

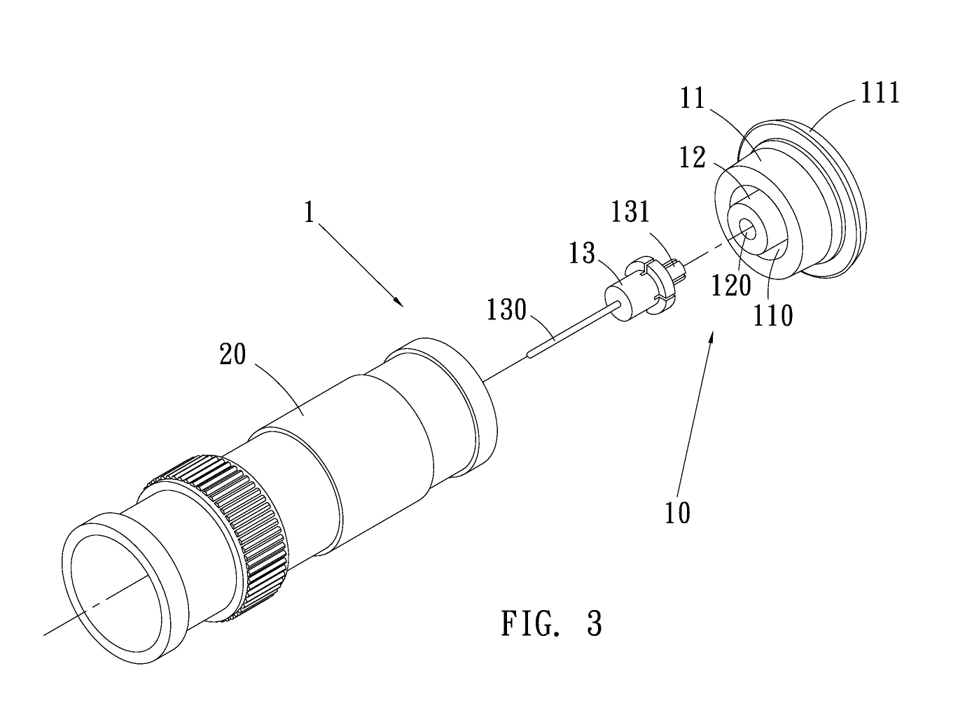

As shown in FIGS. 1 and 3, a connector 1 according to a preferred embodiment of the present invention is a covering member 10 fixed in a connector 20, and the covering member 10 contains an outer tube 11, an inner tube 12, and a needle portion 13, and the outer tube 11 is retained in the connector 20.

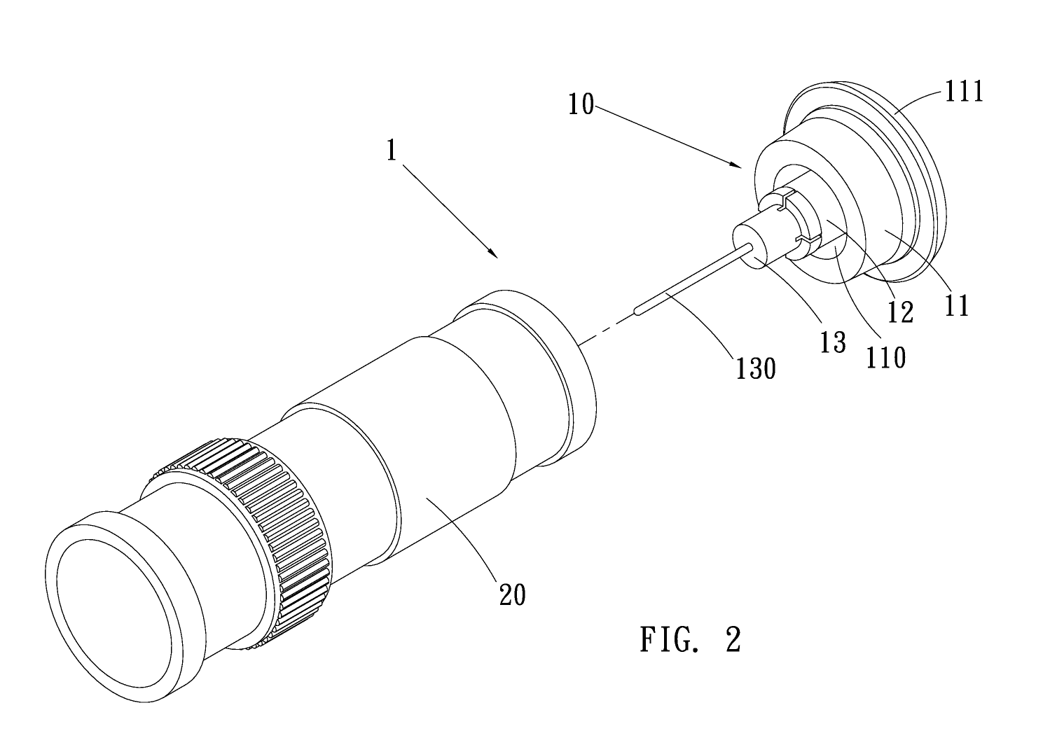

As illustrated in FIG. 2, the covering member 10 is pulled by an external periphery 111 of the outer tube 11 to disengage from the connector 20.

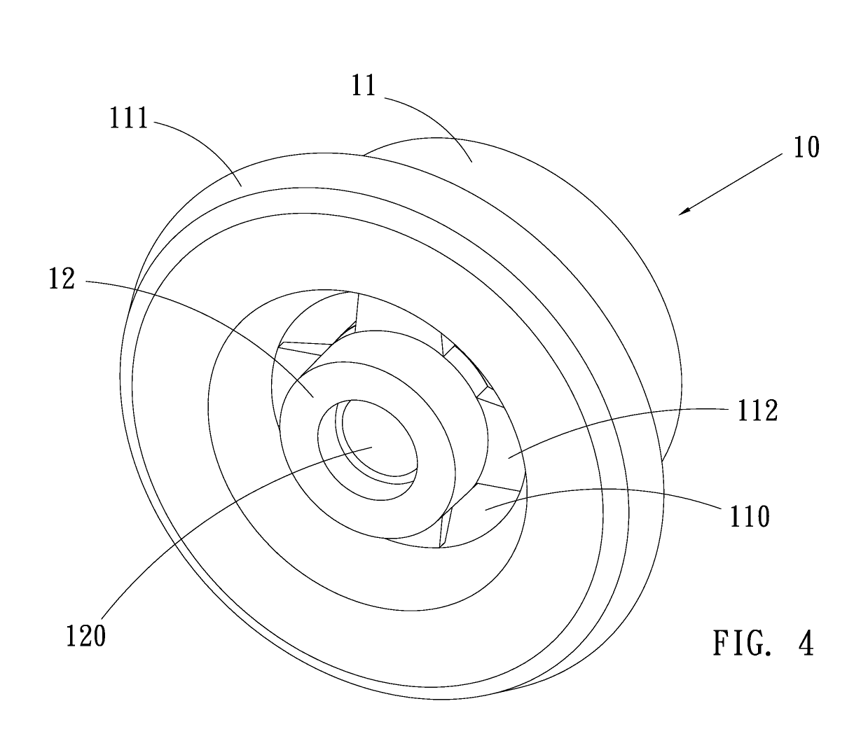

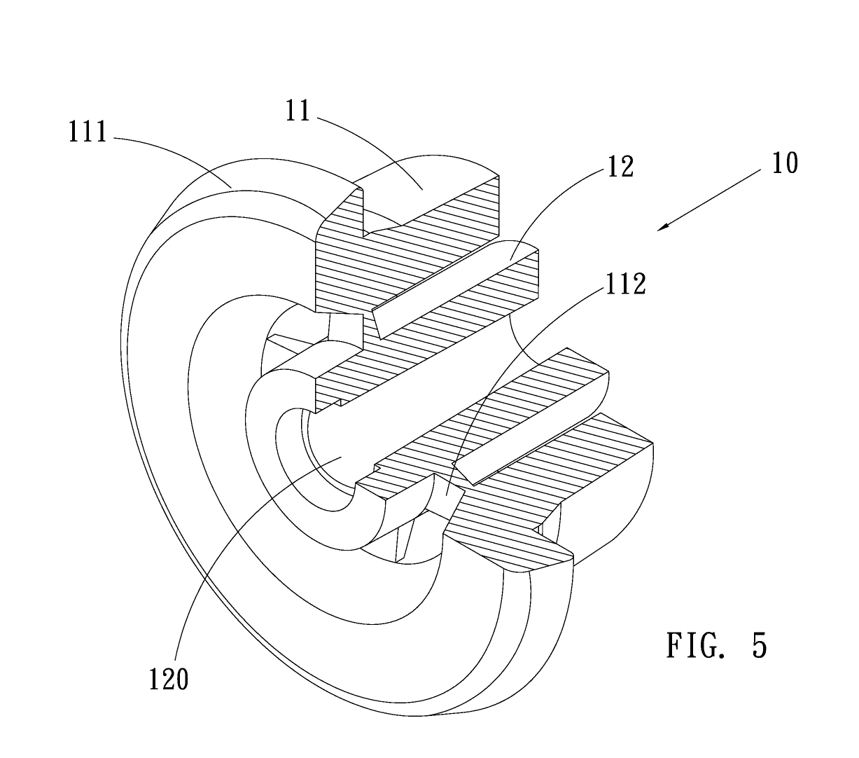

Referring to FIGS. 4 and 5, the outer tube 11 and the inner tube 12 of the covering member 10 are shown, wherein the outer tube 11 and the inner tube 12 are made integrally and separately, when the outer tube 11 and the inner tube 12 are made integrally, between the outer tube 11 and the inner tube 12 are connected a plurality of connecting projections 112, the outer tube 11 has the first hole 110, and the inner tube 12 has a second hole 120.

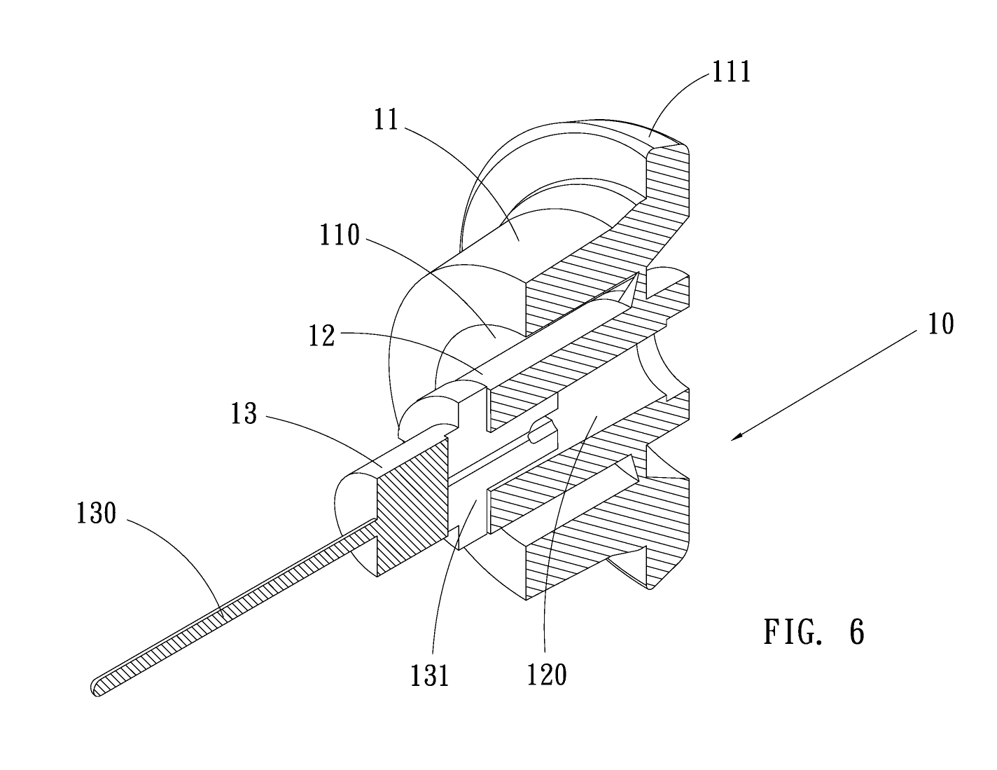

With reference to FIG. 6, the needle portion 13 has a head projection 130 formed thereon to correspond to the connector 20, in assembly, the needle portion 13 is retained in the second hole 120 of the inner tube 12, and the needle portion 13 and the inner tube 12 are received in the first hole 110 of the outer tube 11, the needle portion 13 further has an engaging section 131 to correspond to the connector 20 and a core segment 21 to retain the core segment 21 of a cable 2.

In operation, the needle portion 13 is engaged in the second hole 120 of the inner tube 12 and is received in the first hole 110 of the outer tube 11 with the inner tube 12 so that the outer tube 11 and the needle portion 13 are retained in the connector 20.

Referring to FIGS. 1 and 2, in operation, the needle portion 13 of the covering member 10 is attached on the inner tube 12 and is received in the first hole 110 of the outer tube 11 with the inner tube 12; the covering member 10 is retained in the connector 20 so as to prevent the needle portion 13 separated from the connector and gotten lost.

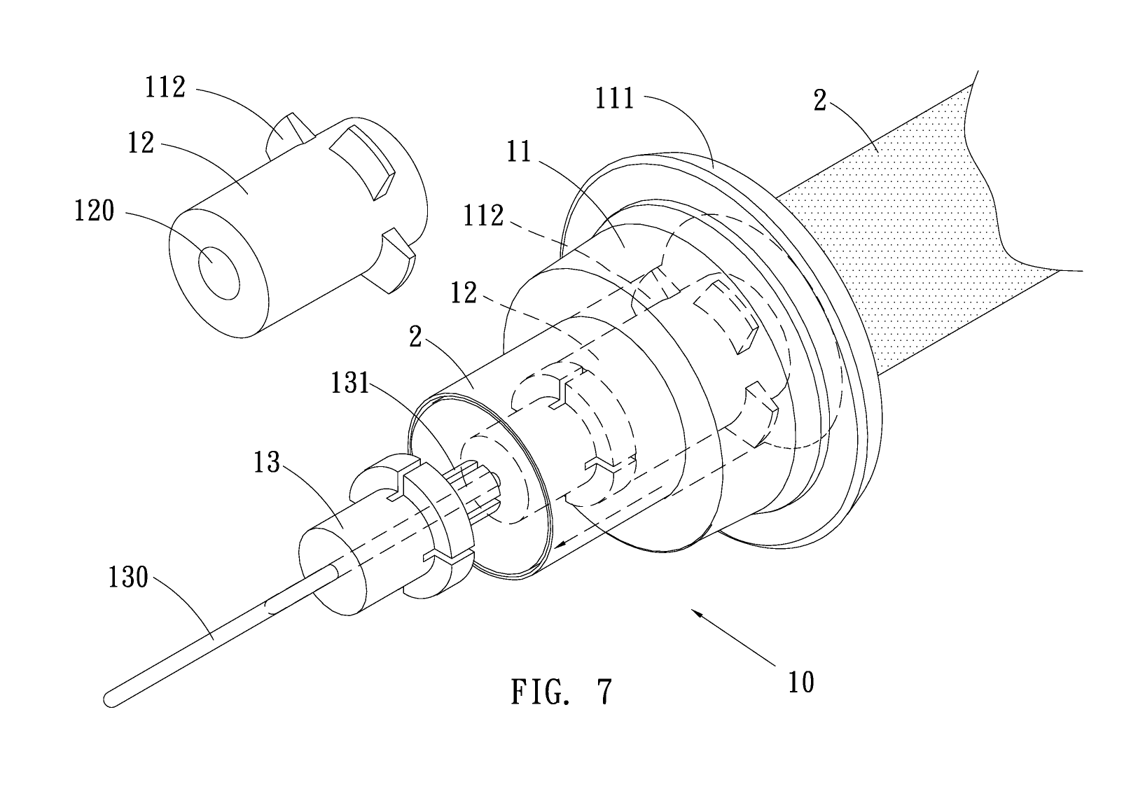

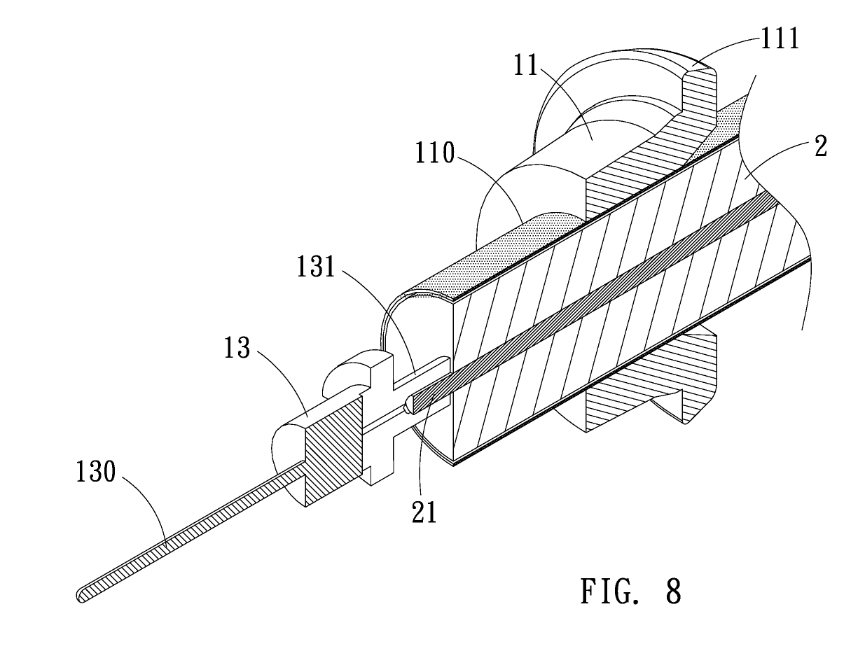

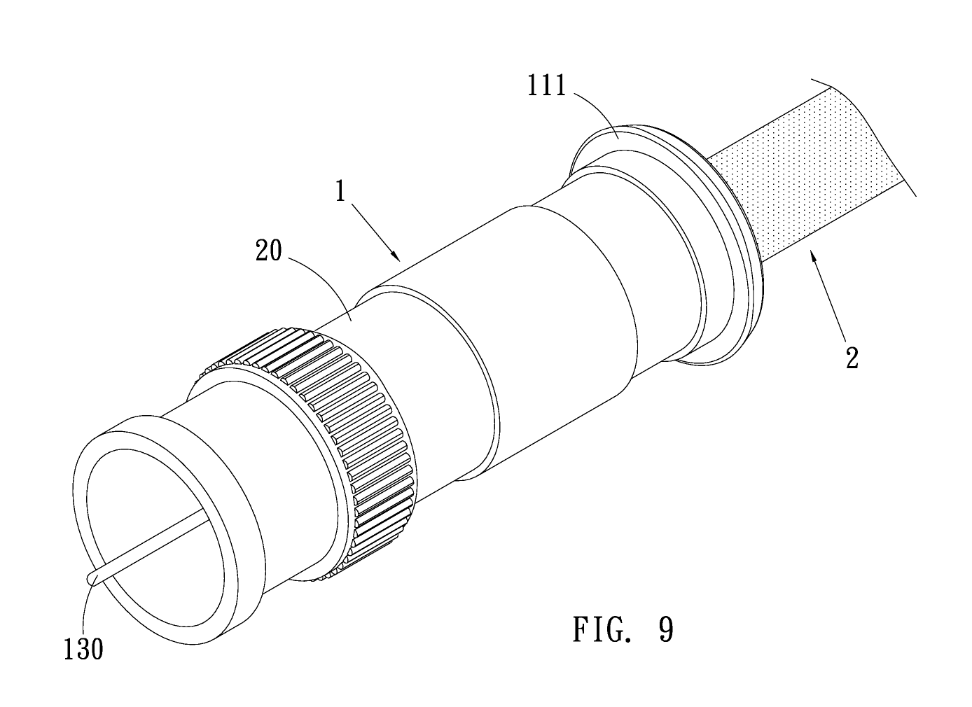

Referring to FIGS. 7-9, the outer tube 11 and the inner tube 12 of the covering member 10 are removable; the inner tube 12 and the needle portion 13 are removable; the external periphery 111 is used to pull the covering member 10 out of the connector 20, and the needle portion 13 is pulled out of the inner tube 12, then the needle portion 13 is attached on the core segment 21, hence the core segment 21 is electrically connected with the head projection 130 by ways of the engaging section 131 to transmit signals. Thereafter, the inner tube 12 is pulled outward, the plurality of connecting projections 112 of the outer tube 11 and the inner tube 12 are torn off, so that the inner tube 12 removes from the outer tube 11 to be discarded, and the cable 2 with the needle portion 13 is inserted in the first hole 110 of the outer tube 11 in which the connector 20 is inserted later, thus obtaining waterproof and anti-lost function of the needle portion 13.

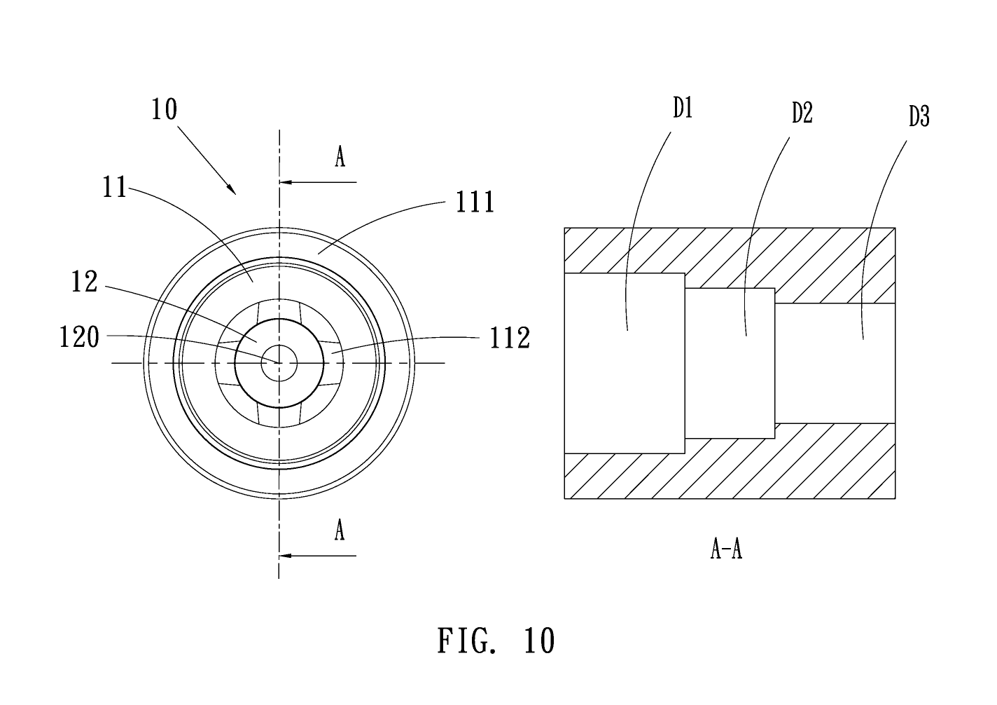

As illustrated in FIG. 10, a diameter of the second hole 120 of the inner tube 12 of the covering member 10 is formed relative to the engaging section 131 of the needle portion 13, and the diameter of the second hole 120 is capable of being formed in different sizes, such as a first-size diameter D1, a second-size diameter D2, and a third-size diameter D3.

While we have shown and described various embodiments in accordance with the present invention, it is clear to those skilled in the art that further embodiments may be made without departing from the scope of the present invention.

What is claimed:

1. A connector for a covering member of a cable comprising:
a connector;
the covering member, including
an outer tube having a first hole, the first hole having an external portion extending outward from a peripheral side of another end thereof, the outer tube being retained in the connector, a bottom end of the external periphery being larger than the first hole;
an inner tube having a second hole;
a needle portion having a head projection and an engaging section; wherein
after the needle portion retains in the second hole of the inner tube, the needle portion and the inner tube are received in the first hole of the outer tube so as to retain in the connector with the outer tube.

2. The connector for the covering member of the cable as claimed in claim 1, wherein the outer tube and the inner tube are made integrally or separately and are removable.

3. The connector for the covering member of the cable as claimed in claim 1, wherein between the outer tube and the inner tube are connected a plurality of connecting projections.

4. The connector for the covering member of the cable as claimed in claim 1, wherein a diameter of the second hole of the inner tube is formed relative to the engaging section of the needle portion.

5. The connector for the covering member of the cable as claimed in claim 1, wherein the head projection of the needle is formed to correspond to the connector.

6. The connector for the covering member of the cable as claimed in claim 1, wherein the needle portion has an engaging section to correspond to the connector and a core segment.

7. The connector for the covering member of the cable as claimed in claim 1, wherein the connector is any kind of connectors.
